(19) United States
(12) Patent Application Publication
(10) Pub. No.: US 2021/0153518 A1
(43) Pub. Date: May 27, 2021

(54) FOAMING CREAMER COMPOSITION

(71) Applicant: SOCIETE DES PRODUITS NESTLE S.A., Vevey (CH)

(72) Inventors: Chrystel Loret, Lausanne (CH); Lucile Waksman, Bern (CH); Anne-Juliette Dedisse, Bern (CH); Cecile Gehin-Delval, Les Hopitaux Neufs (FR); Martin Erwin Leser, Bretigny-sur-Morrens (CH)

(21) Appl. No.: 16/633,006

(22) PCT Filed: Jul. 16, 2018
(86) PCT No.: PCT/EP2018/069224

§ 371 Date: Jan. 22, 2020

(30) Foreign Application Priority Data
Jul. 27, 2017 (EP) 17183479.9

(51) Int. Cl. A23C 11/08; A23F 5/40

(52) U.S. Cl. CPC A23C 11/08; A23C 2260/20; A23F 5/40

(57) ABSTRACT

There is provided a foaming creamer composition, said composition comprising casein or a salt thereof and an oil, wherein the weight ratio of casein or salt thereof to oil is about 0.005:1 to about 0.035:1, preferably about 0.010:1 to about 0.030:1; preferably about 0.012:1 to about 0.028:1, more preferably about 0.015:1 to about 0.025:1; and a foamer ingredient comprising gas under pressure. Also provided are uses of said creamer composition together with a process of preparing a creamer composition.

### FIELD OF THE INVENTION

The present invention relates to foaming creamer compositions and to processes for producing creamer compositions.

### BACKGROUND TO THE INVENTION

Creamers are widely used as whitening agents with hot and cold beverages such as, for example, coffee, cocoa, tea, etc. They are commonly used in place of milk and/or dairy cream. Creamers may come in a variety of different flavours and provide mouthfeel, body, and a smooth texture. Creamers can be in liquid or powder forms. For some applications, e.g. for the easy preparation of cappuccino-type coffee beverages, creamers that produce a high amount of foam on top of a beverage is desired. WO 01/08504 discloses a foaming ingredient which contains gas under pressure and produces a high amount of foam when reconstituted in water. Such a foaming ingredient may be used as part of a foaming creamer, e.g. in an instant cappuccino beverage powder.

Both consumers and health authorities seek nutritionally balanced foods and beverages with reduced calorie content. In addition, many consumers look for enhanced mouthfeel, also denoted as richness, texture or creaminess, of foods and beverages. At the same time, many foods and beverages are transitioning from high fat and high sugar versions to versions with reduced fat and reduced sugar content in order to limit the calorie content.

However, a reduction in fat and/or sugar content can result in a less pleasing texture, mouthfeel and taste of the foam formed by foaming creamer compositions. Emulsified fat contributes considerably to the in-mouth sensory quality of the foam produced by a foaming creamer, and these qualities may be partly or totally lost when fat content is reduced.

Creamers, such as non-dairy creamers, may use casein or a salt thereof, e.g. sodium caseinate, as a protein component. The sodium caseinate functions as an emulsifier to stabilise the oil component in the creamer. The amount of sodium caseinate present in the creamer is a balance between the need to emulsify the oil component of the creamer, and the need to avoid undesirable coagulation of protein in the beverage to which the creamer is added. In order to obtain good emulsion stability, the sodium caseinate is typically present in the creamer in an amount between 6% and 45%, calculated in percentage on the total oil+emulsifier amount in the system. In CA1046836 a powdered creamer composition is described in which the sodium caseinate (NaCas) percentage is between 7% (3% NaCas for 40% fat in the powder) and 43% (15% NaCas for 20% fat in the powder).

There is therefore a need in the art for a means to enhance the texture, mouthfeel and taste of foam produced by foaming creamers without increasing the overall fat content.

### SUMMARY OF THE INVENTION

The present invention solves the above prior art problems by providing foaming creamer compositions as described in the claims. Accordingly, the present invention relates to a foaming creamer composition, said composition comprising: a) an emulsion comprising casein or a salt thereof and an oil, wherein the weight ratio of casein or salt thereof to oil is about 0.005:1 to about 0.035:1, preferably about 0.010:1 to about 0.030:1; preferably about 0.012:1 to about 0.028:1, more preferably about 0.015:1 to about 0.025:1; and b) a foamer ingredient comprising gas under pressure. In further aspects the present invention relates to use of o foaming creamer of the invention and a process for providing a foaming creamer of the invention.

### BRIEF DESCRIPTION OF THE FIGURES

FIG. 1 shows storage and loss moduli measured by oscillatory rheology of a reference Cappuccino (reference) versus a Cappuccino made with creamer of the present invention (Variant 1). See example 1 for details.

### DETAILED DESCRIPTION OF THE INVENTION

Unless otherwise stated, weight percentage values (wt. % or %) described herein are given with respect to the wt. % of the stated ingredient in a dry matter, excluding any water present in the composition.

By a foaming creamer composition is meant a composition that is intended to be added to a food and/or beverage composition, such as e.g. coffee, tea or soup, to produce a foam layer on top of the food or beverage composition, and may additionally impart other characteristics such as colour (e.g. whitening effect), thickening, flavour, texture, and/or other desired characteristics. A creamer composition of the invention is preferably in powdered form.

Advantageously, the foaming creamer compositions of the invention produce a foam layer on top of a beverage or liquid food product, which provides an improved texture and taste perception by the consumer, without increasing the overall fat content of the beverage or liquid food product. This is achieved by the amount of casein or salt thereof present in the creamer relative to the amount of lipid component and the use of a foaming ingredient comprising gas under pressure.

The present invention provides in one aspect a foaming creamer composition, said composition comprising a) an emulsion comprising casein or a salt thereof and an oil wherein the weight ratio of casein or salt thereof to oil is about 0.005:1 to about 0.035:1, preferably about 0.010:1 to about 0.030:1; preferably about 0.012:1 to about 0.028:1, more preferably about 0.015:1 to about 0.025:1; and b) a foamer ingredient comprising gas under pressure

The weight ratio of casein or salt thereof to oil in said emulsion may be about 0.005:1, 0.006:1, 0.007:1, 0.008:1, 0.009:1, 0.010:1, 0.011:1, 0.012:1, 0.013:1, 0.014:1, 0.015:1, 0.016:1, 0.017:1, 0.018:1, 0.019:1, 0.020:1, 0.021:1, 0.022:1, 0.023:1, 0.024:1, 0.025:1, 0.026:1, 0.027:1, 0.028:1, 0.029:1, 0.030:1, 0.031:1, 0.032:1, 0.033:1, 0.034:1 or 0.035:1.

In one aspect, the function of the casein or salt thereof of the foaming creamer is to emulsify and thus stabilise the oil component of the foaming creamer when added to a liquid food or a beverage.

The present inventors have surprisingly found that by reducing the amount of casein or salt thereof present in the creamer relative to the oil component, such that the weight ratio of casein or salt thereof to oil in the creamer composition falls within the range of about 0.005:1 to about 0.035:1, the creamer advantageously produces a foam layer at the top of a liquid food (for example a soup) or a beverage (for example tea or coffee) with improved texture, mouthfeel and/or taste as compared to that produced by a regular (prior art) creamer.

Without wishing to be bound by theory, the present inventors believe that the improved texture, mouthfeel and/or taste of the foam layer produced by the creamers of the invention is due to oil droplets that form aggregates and rise to the top of the liquid food or beverage due to their reduced density compared to the aqueous component of the liquid food or beverage, and are caught in the foam. The inventors have surprisingly found that by reducing the concentration of casein or salt thereof present in the creamer at a constant oil content, the reduction in emulsification of oil droplets provides for increased oil droplet aggregation.

The weight ratio of casein or salt thereof to oil component in the emulsion is important to the sensory characteristics of the foam layer. If too much casein or salt thereof is present compared to the oil component, then there is no aggregation of the oil droplets in the final product. However, if the concentration of casein or salt thereof is too low, then excessive oil droplet aggregation and/or coalescence will destabilise the emulsion during homogenization and emulsion concentrate formation and/or drying of the concentrate.

Casein is a protein that may be found in mammalian milk. Casein and casein salts are commonly used in a variety of food products. The casein or salt thereof described herein may comprise α-casein, β-casein and/or γ-casein.

The casein or salt thereof used in the emulsion may be micellar casein, sodium caseinate, potassium caseinate or calcium caseinate; preferably the casein or salt thereof is sodium caseinate. While casein and salts thereof are derived from a milk protein, when used in food products they are typically not regarded as a true dairy substance, due to having undergone processing. Accordingly, creamers comprising casein or a salt thereof such as sodium caseinate may be described as non-dairy creamers.

The oil component of the emulsion may be an oil such as palm oil, palm kernel oil or olein, hydrogenated palm kernel oil or olein, coconut oil, algal oil, canola oil, soy bean oil, sunflower oil, safflower oil, cotton seed oil, milk fat, or corn oil, or high oleic variants of oils such as high oleic soybean, high oleic canola, high oleic safflower, or high oleic sunflower oil.

In a preferred embodiment, the emulsion is in the form of a powder. The powder may be obtained by drying of a liquid emulsion. The drying step may be performed by spray drying, vacuum band drying, roller drying or freeze drying, or any other appropriate method known in the art. In a preferred embodiment, the powder is obtained by spray drying.

In spray drying, a liquid is sprayed through a small nozzle into a heated drying gas. This produces a dried powder or particles which can subsequently be collected. Spray drying methods are known in the art and would be familiar to a skilled person.

### Foamer Ingredient

The creamer composition of the invention comprises a foamer ingredient comprising gas under pressure. By comprising gas under pressure is meant that gas is enclosed in closed pores of the ingredient with a pressure inside the pores which is higher than ambient atmospheric pressure. This kind of foamer ingredients may be able to release volumes of gas (when measured at ambient atmospheric pressure) which are higher than what can be released by porous foamer ingredients with open pores and comprising gas under ambient pressure. Suitable foamer ingredients comprising gas under pressure and methods of producing them are disclosed in WO 01/08504, WO 2006/023565 and WO 2006/023564.

A suitable foamer ingredient comprising gas under pressure is a foamer ingredient comprising a matrix containing carbohydrate, protein and entrapped gas. The carbohydrate in the matrix may be any suitable carbohydrate or carbohydrate mixture. Suitable examples include lactose, dextrose, fructose, sucrose, maltodextrin, corn syrup, starch, modified starch, cyclodextrin, dextrose, fructose, and the like, and mixtures of these carbohydrates. Mixtures containing maltodextrin are particularly preferred. For example, the carbohydrate may be a mixture of about 40% to about 80% by weight of maltodextrin, sucrose and lactose. Sucrose preferably provides about 5% to about 30% by weight of the mixture. Lactose preferably provides about 5% to about 30% by weight of the mixture. Maltodextrin preferably provides 10% to 50% by weight of the mixture. The carbohydrate preferably provides about 40% to about 98%; more preferably about 60% to about 95% by weight of the matrix; and even more preferably about 70% to about 90% by weight. The protein in the matrix may be any suitable protein or protein mixture. The protein can be replaced by another ingredient with a similar functionality such as suitable emulsifiers. Suitable emulsifiers include monoglycerides, diglycerides, lecithin, diacetyl tartaric acid esters of mono-diglycerides (data esters), emulsifying starches and mixtures thereof. Suitable examples of protein include milk proteins (casein or whey, or both), soy proteins, wheat proteins, gelatin, caseinates, and the like. A particularly suitable source of protein is non-fat milk solids. These solids may be provided in dry or liquid form (as skimmed milk). Another suitable source of protein is sweet whey, for example in the form of sweet whey powder. Sweet whey powder usually contains a mixture of lactose and whey protein. If the protein is provided by protein source such as non-fat milk solids or sweet whey, the protein source will usually also provide some carbohydrate in the form of lactose. The matrix may contain fat as an ingredient. The fat in the matrix may be any suitable fat or fat mixture. Suitable examples include milk fat, vegetable fat and animal fat. The origin of the fat, its composition and its physical characteristics such as melting or crystallisation temperatures may influence both the foaming capacity of the soluble foamer ingredient and the stability of the foam obtained. A gas is entrapped in the matrix. The gas may be any suitable food grade gas. For example, the gas may be nitrogen, carbon dioxide or atmospheric air, and mixtures of these gases. Gases which are substantially inert are preferred. To provide the enhanced foaming, the gas is introduced into the matrix under pressure; for example at above about 100 kPa gauge. Preferably, the gas is introduced into the matrix at above about 500 kPa gauge; for example at about 1 MPa to about 20 MPa. The gas may be introduced into the matrix by any suitable process. One suitable technique involves providing the matrix in the form of expanded particles and then entrapping gas in the particles. The expanded particles may be produced by injecting a gas into an aqueous matrix concentrate having a solids content above about 30% by weight and then spray drying the concentrate to powder. The gas may be injected into the aqueous matrix concentrate at a pressure of about 500 kPa to about 5 MPa. However, the pressure at which the gas is injected into the matrix concentrate is not critical. The gassed aqueous matrix is then spray dried to powder. The particles are then subjected to an inert gas atmosphere at high pressure and at a temperature above the glass transition temperature of the particles. The pressure may be from about 100 kPa gauge to about 20 MPa gauge. The temperature needed will depend upon the composition of the particles since this will influence the glass transition temperature. However, the temperature may be readily set for any particle type by the skilled person. Temperatures more than about 50° C. above the glass transition temperature are probably best avoided. The particles may be subjected to the pressure and temperature for as long as desired since increasing the time will generally increase the gas entrapment. Usually times of about 10 seconds to about 30 minutes are sufficient. The particles are then subjected to rapid quenching or curing to ensure entrapment of the gas. Rapidly releasing the pressure may well be sufficient to quench the particles. Otherwise suitable cooling procedures may be used. Another suitable technique involves injecting gas into a molten mass of the matrix which contains little or no moisture; for example in an extruder. The gas may be injected at a pressure of about 100 kPa gauge to about 20 MPa gauge. The temperature required will depend upon the composition of the matrix since this will influence the melt temperature. However, the temperature may be readily set for any matrix by the skilled person. Generally, however, temperatures above about 150° C. should be avoided. The molten mass may then be extruded through a small orifice and comminuted into a powder. Depending upon the rapidity of solidification of the matrix, the matrix may need to be cured or quenched under pressure before being formed into a powder. This will prevent the gas from escaping from the matrix. The curing or quenching is preferably carried out rapidly but the time may vary from about 10 seconds to about 90 minutes.

In one embodiment of the invention the amount of gas released from the foamer ingredient by contact with a liquid is at least 1 ml, such as at least 2 ml, at least 3 ml or at least 5 ml, of gas at ambient conditions per gram of foamer ingredient.

The amount of foamer ingredient comprising gas under pressure may be varied according to the amount of gas released per gram of foamer ingredient, the desired volume of foam, the nature and amounts of the other components of the creamer, and may typically be in the range of between 5 and 70% by weight, such as between 10 and 50% by weight, between 15 and 40% by weight, or between 20 and 30% by weight.

The creamer composition of the invention may contain one or more further components, such as, for example, a sweetener (e.g. a sugar), sodium chloride, a buffer and/or a low molecular weight emulsifier or flavours. In a preferred embodiment, the oil comprises one or more added aroma components. By an added aroma component is meant an aroma or flavour component which is not naturally part of the oil. For example, if the creamer is intended to be used with coffee, coffee aroma and/or flavour may be added to the oil to increase the perceived coffee aroma and/or flavour of the final beverage.

A sweetener, such as a sugar (e.g. glucose), provides a desired sweet taste when the creamer is added to a liquid food or a beverage. As an alternative to sugar, an artificial sweetener may be used.

Sweeteners can include, for example, sucrose, fructose, dextrose, maltose, dextrin, levulose, tagatose, galactose, corn syrup solids and other natural or artificial sweeteners. Sugarless sweeteners can include, but are not limited to, sugar alcohols such as maltitol, xylitol, sorbitol, erythritol, mannitol, isomalt, lactitol, hydrogenated starch hydrolysates, and the like, alone or in combination. Usage level of the sweeteners will vary and will depend on such factors as potency of the sweetener, desired sweetness of the product and cost considerations. Combinations of sugar and/or sugarless sweeteners may be used. In one embodiment, a sweetener is present in the creamer composition of the invention at a concentration ranging from about 5-90% by weight of the total composition, such as in the range 20-90%, preferably such as 20-70%. In another embodiment, the sweetener concentration ranges from about 40% to about 60% by weight of the total composition. If an artificial sweetener is used, it is suitably combined with bulking agents such as maltodextrins and polydextrose.

The creamer composition of the invention may comprise a buffer and stabilizing agents. The buffer and stabilizing agent can prevent undesired creaming or precipitation of the creamer upon addition into a hot, acidic environment such as coffee. Examples of suitable buffers and stabilizing agents include monophosphates, diphosphates, triphosphates, hexamethaphosphates, sodium mono- and bicarbonates, potassium mono- and bicarbonates, or a combination thereof. Preferred buffers and stabilizing agents are salts such as potassium phosphate, dipotassium phosphate (also known as potassium phosphate dibasic), potassium hydrophosphate, sodium bicarbonate, sodium citrate, sodium phosphate, disodium phosphate, sodium hydrophosphate, sodium tripolyphosphate and hexametaphosphates. The buffer and stabilizing agents may be present in an amount of about 0.1 to about 3% by weight of the creamer composition.

The creamer composition of the invention may comprise a low molecular weight emulsifier. A low molecular weight emulsifier may be an emulsifier with a molecular weight below 1500 g/mol. The term low molecular weight emulsifier as defined herein does not include casein or casein salts.

Examples of low molecular weight emulsifiers include monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides, lecithins, lysolecithins, succinic acid esters of mono- and/or diglycerides, lactic acid esters of mono- and/or diglycerides, lecithins, lysolecithins, proteins and sucrose esters of fatty acids, lecithin (e.g. soy lecithin, canola lecithin, sunflower lecithin, and/or safflower lecithin), lysolecithins, and combinations thereof.

The low molecular weight emulsifier may be present in the composition in an amount of, for example, about 0.1 wt. % to about 0.5 wt. %.

However, the inventors have determined that low molecular weight emulsifiers are not essential for the creamer compositions of the invention. Thus, a creamer composition of the invention may lack any low molecular weight emulsifier.

In one embodiment, the creamer composition comprises about 0.20 wt. % to about 1.20 wt. % casein or salt thereof, for example about 0.40 wt. % to about 0.96 wt. % casein or salt thereof, about 0.40 wt. % to about 0.90 wt. %, about 0.45 wt. % to about 0.85 wt. %, about 0.50 wt. % to about 0.85 wt. %, about 0.55 wt. % to about 0.85 wt. %, or about 0.60 wt. % to about 0.80 wt. %.

The creamer composition may comprise about 0.40 wt. %, 0.45 wt. %, 0.50 wt. %, 0.55 wt. %, 0.60 wt. %, 0.65 wt. %, 0.70 wt. %, 0.75 wt. %, 0.80 wt. %, 0.85 wt. %, 0.90 wt. %, 0.95 wt. %, 0.96 wt. %, 1.00 wt. %, 1.05 wt. %, 1.10 wt. %, 1.15 wt. % or 1.20 wt. % casein or salt thereof.

The creamer composition may comprise about 10 wt. % to about 80 wt. % oil, for example about 10 wt. % to about 50 wt. %, about 20 wt. % to about 40 wt. %, or about 20 wt. % to about 35 wt. %.

The creamer composition may comprise about 10, 15, 20, 25, 30, 35, 40, 50 or 80 wt. % oil.

In one embodiment, the creamer composition may comprise about 0.40 wt. % to about 1.20 wt. % casein or salt thereof and about 30 wt. % to about 35 wt. % oil, preferably about 34 wt. % oil.

In one embodiment, the creamer composition may comprises about 0.40 wt. % to about 0.96 wt. % casein or salt thereof and about 30 wt. % to about 35 wt. % oil, preferably about 34 wt. % oil.

The creamer composition of the invention may be a beverage creamer, for example a coffee creamer. Beverage creamers are commonly used as a substitute for milk to whiten beverages such as tea or coffee.

As described above, the creamer composition of the invention may be used to form a creamy layer on top of a liquid food or a beverage. The creamy layer comprises a plurality of oil droplet aggregations. In certain embodiments, the creamy layer may be a creamy foam layer, formed by the presence of gas bubbles. They can be released from the creamer composition or another ingredient in the recipe that contains gas.

The creamy layer formed by the creamer composition of the invention comprises a significant proportion of the total amount of oil present in the creamer, in the form of oil droplets in the creamy layer. As it is the presence of oil in the creamy layer that increases the perception of creaminess, this property of the creamer compositions can advantageously provide improved texture properties without increasing the overall fat content of the liquid food or beverage.

In one embodiment, up to about 25% to about 80% by weight of the oil component of the composition may be present in the creamy layer; preferably about 45% to about 80% by weight; for example about 45% to about 65%.

The oil droplet aggregates in the creamy layer may have, for example, a mean size of about 20 μm to about 40 μm. Mean size is determined as D(4,3), the volume weighted mean aggregate size. Particle size measurements may be carried out using a Malvern Mastersizer with a Hydro 2000G dispersion unit.

In addition to the above, use of a creamer composition of the invention in a beverage such as coffee has the effect of decreasing the whiteness of the bulk phase of the beverage below the creamy layer. This phenomenon is caused by the increased movement of oil droplets from the bulk phase to the creamy layer, leading to a darkening of the bulk phase and a pleasing aesthetic appearance of the beverage.

The creamer composition may be combined with coffee (for example a dried coffee such as dried instant coffee powder) to form a coffee beverage composition. Thus, in one aspect, the invention provides a coffee beverage composition comprising the creamer composition of the invention and a coffee component. For example, when the coffee beverage composition is reconstituted in water at a temperature of at least 70° C. (for example, about 70° C. to about 95° C., or about 80° C. to about 90° C.; or about 70, 75, 80, 85 or 90° C.) a coffee beverage with a creamy layer on top of the beverage is formed, the creamy layer comprising a plurality of oil droplet aggregations. When the creamer is a gassed creamer as described above, gas bubbles released from the creamer enable the formation of a creamy foam layer.

A dried creamer composition of the present invention may be formed by a process comprising the steps of:

(i) providing an aqueous phase comprising casein or a salt thereof;
(ii) providing an oil phase comprising an oil, and optionally a low molecular weight emulsifier;
(iii) combining the aqueous phase and the oil phase to form a pre-emulsion;
(iv) homogenising the pre-emulsion to form an emulsion concentrate;
(v) drying (e.g. spray drying) the emulsion concentrate to form a dried composition;
(vi) mixing the dried emulsion with a powdered foamer ingredient comprising gas under pressure.

The process may comprise a step of pasteurizing or commercially sterilising the pre-emulsion or emulsion concentrate. The pasteurizing step may, for example, be performed at a minimum temperature of at least 81° C. for at least 5 seconds.

The aqueous phase may be prepared by adding the casein or salt thereof, and optionally other water soluble ingredients such as, for example, a sweetener, sodium chloride, flavours, aromas and/or a buffer, to water and mixing.

The oil phase may be prepared using the oil component of the composition and optionally combining this with low molecular weight emulsifiers. If an added oil soluble aroma and/or flavour component in the oil is desired, it may be added and mixed into the oil before the oil is combined with the aqueous phase.

The aqueous phase and the oil phase may be combined, for example, at a temperature of about 60° C. to about 80° C., for example about 60, 65, 70, 75 or 80° C., to form a pre-emulsion.

The pre-emulsion may be homogenised at high pressures using protocols known in the art. By way of example, the pre-emulsion may be homogenised using two runs at a pressure of 250/50 bars. Alternatively, the pre-emulsion may be homogenised using three runs at pressures of 300 bars for two runs and 50 bars for a third run.

The term “homogenise” or “homogenised” is a unit operation using a class of processing equipment referred to as homogenisers that are geared towards reducing the size of droplets in liquid-liquid dispersions. Examples of homogenisers may include high speed blender, high pressure homogenisers, Colloid Mill, high shear dispersers, ultrasonic disruptors, and membrane homogenisers.

Subsequently, the obtained emulsion concentrate is dried (for example, by spray drying), optionally following a gas addition step under high pressure (e.g. wherein the drying is spray drying, at approximately 20 to 50 bars above the spraying pressure).

### EXAMPLES

### Example 1 Cappuccino Beverage Comprising Creamer of the Invention

### Reference

A reference powdered cappuccino beverage composition was prepared by pouring hot water to dissolve a dry mix of soluble coffee, creamer, foaming agent and sugar.

The composition was as shown in the table below:

| Ingredient | Cappuccino Ref (g) |
|---|---|
| Foaming agent | 4.0 |
| Reference Creamer | 4.5 |
| Sugar | 6.5 |
| Coffee | 2.0 |

Cappuccino Beverage with Creamer Composition of the Invention:

A powdered cappuccino beverage comprising the creamer composition of the invention was prepared by pouring hot water to dissolve a dry mix of soluble coffee, non-dairy creamer with the composition of the invention, foaming agent and sugar.

The composition was as shown in the table below:

| Ingredient | Cappuccino 1 (g) |
|---|---|
| Foaming agent | 4.0 |
| Creamer of present invention | 4.5 |
| Sugar | 6.5 |
| Coffee | 2.0 |

### Rheological Measurements

The cappuccino beverage powders where dissolved in water by adding 180 mL of water at 85° C., mixing by hand with a spoon clock wise and counter clock wise for 10 seconds.

The composition of the creamers for the rheological measurements are as shown in the tables below:

Creamer of present invention

| | |
|---|---|
| Di Potassium Phosphate | 2.1% |
| Salt Sodium Chloride | 0.2% |
| Caseinate Sodium | 0.8% |
| Glucose Syrup DE 28-33 | 61.8% |
| Oil Palm Kernel Fully Hydrogenated | 35.1% |

Reference creamer for Rheological measurements

| | |
|---|---|
| Milk Skimmed | 38.8% |
| Di Potassium Phosphate | 1.2% |
| Sodium Hexametaphosphate | 0.7% |
| Trisodium Citrate | 0.3% |
| Oil Coconut | 25.1% |
| Glucose Syrup DE 28-33 | 33.9% |

The storage modulus G′ was measured by oscillatory rheology. To do so, foam was generated in a measuring cell and drained liquid removed. The linear zone was then pre-determined, and the measurement done at frequency sweeps from 1 to 100 rad·s⁻¹ for a stress of 0.025 Pa.

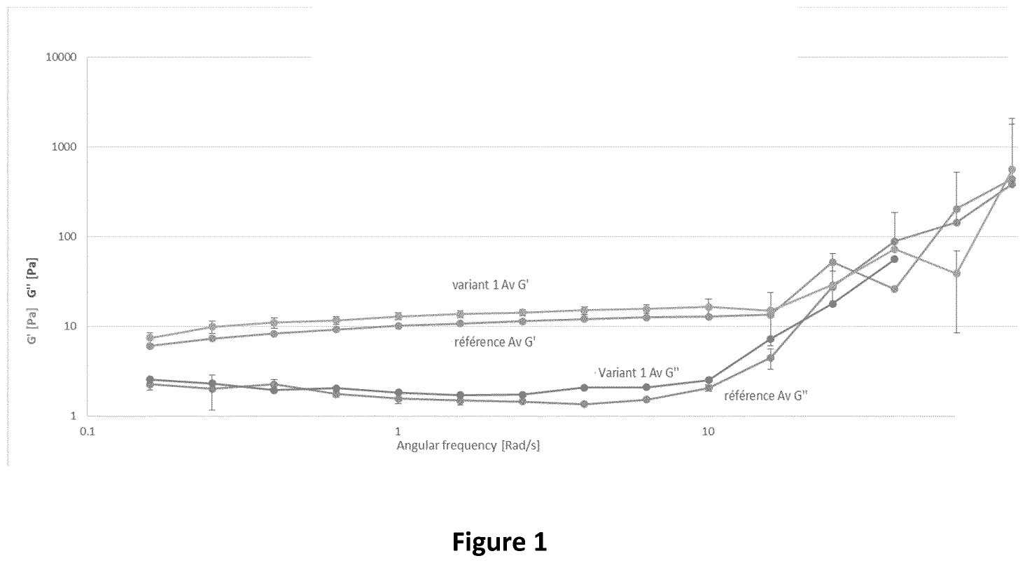

Results are shown in FIG. 1. It was found that the storage modulus (G′) was significantly higher for the cappuccino beverage comprising the creamer composition of the invention than for the reference cappuccino beverage.

### Sensory Analysis

The cappuccino beverage powders were dissolved in water by adding 180 mL of water at 85° C., mixing by hand with a spoon clock wise and counter clock wise for 10 seconds.

The Cappuccinos had the composition described above, with the following creamer recipes:

Creamer of present invention

| | |
|---|---|
| Di Potassium Phosphate | 2.1% |
| Salt Sodium Chloride | 0.2% |
| Caseinate Sodium | 0.8% |
| Glucose Syrup DE 28-33 | 61.8% |
| Oil Palm Kernel Fully Hydrogenated | 35.1% |

Reference creamer for sensory analysis

| | |
|---|---|
| Di Potassium Phosphate | 2.1% |
| Sodium Tripolyphosphate | 0.4% |
| Salt Sodium Chloride | 0.2% |
| Caseinate Sodium | 2.4% |
| Glucose Syrup DE 28-33 | 59.9% |
| Oil Palm Kernel Fully Hydrogenated | 35.1% |

Sensory analysis (triangular test) was conducted by an internal panel of 32 tasters. The two samples were found to be significantly different; difference was perceived by 19 out of the 32 tasters. The foam of the cappuccino beverage comprising the creamer composition of the invention was found to be thicker and creamier by some of the tasters.

### Example 2 Cappuccino Beverage Comprising Creamer of the Invention

### Reference

A reference powdered cappuccino beverage composition was prepared by pouring hot water to dissolve a dry mix of soluble coffee, creamer, foaming agent and sugar.

The composition was as shown in the table below:

| Ingredient | Cappuccino Ref (g) |
|---|---|
| Foaming agent | 4.0 |
| Reference Creamer | 4.5 |
| Sugar | 6.5 |
| Coffee | 2.0 |

Cappuccino Beverage with Creamer Composition of the Invention:

A powdered cappuccino beverage comprising the creamer composition of the invention was prepared by pouring hot water to dissolve a dry mix of soluble coffee, non-dairy creamer with the composition of the invention, foaming agent and sugar.

The composition was as shown in the table below:

| Ingredient | Cappuccino 1 (g) |
|---|---|
| Foaming agent | 4.0 |
| Creamer of present invention | 4.5 |
| Sugar | 6.5 |
| Coffee | 2.0 |

The composition of the creamers were as shown in the table below (% by weight):

| | Reference creamer | Inventive creamer |
|---|---|---|
| Di Potassium Phosphate | 2.1% | 2.1% |
| Na HMP | 0.5% | 0% |
| Sodium Hexametaphosphate | 0.6% | 0% |
| NaCl | 0.2% | 0.2% |
| Trisodium Citrate | 2.3% | 0.8% |
| Dimodan emulsifier | 0.4% | 0% |
| Panodan emulsifier | 0.1% | 0% |
| Glucose Syrup DE28-33 wheat | 59% | 61.6% |
| Hydrogenated Palm Kernel Oil | 34% | 34% |

### Rheological Measurements

The cappuccino beverage powders where dissolved in water by adding 180 mL of water at 85° C., mixing by hand with a spoon clock wise and counter clock wise for 10 seconds.

The storage modulus G′ was measured by oscillatory rheology. To do so, foam was generated in a measuring cell and drained liquid removed. The linear zone was then pre-determined, and the measurement done at frequency sweeps from 1 to 100 rad·s⁻¹ for a stress of 0.025 Pa. Yield stress, viscosity at 0.5 Pa, and viscosity at yield stress were determined for both samples.

Results are shown in the table below.

| | Reference | Cappuccino of |
|---|---|---|
| | cappuccino | invention |
| Yield stress (Pa) | 0.8270 | 1.7368 |
| Viscosity at Yield stress (Pa · s) | 92.07 | 219.051 |
| Viscosity at 0.5 Pa (Pa · s) | 72.52 | 113.64 |
| Std. dev. Yield stress (Pa) | 0.1695 | 0.0834 |
| St. dev. Viscosity at Yield stress (Pa · s) | 21.66 | 25.66 |
| St. dev. Viscosity at 0.5 Pa (Pa · s) | 8.6232 | 19.4667 |

### Foam Analysis

Foam created by dissolution of the two cappuccinos above (inventive sample and reference) was analyzed using a Dynamic Foam Analyzer (DFA100, Krüss, Germany). Samples were reconstituted with water in the measuring cell. The resulting foam was observed from the side view through a prism. Images were analyzed with the Krüss software to provide the bubble size distribution at 0 and 5 minutes after reconstitution. Sauter mean bubble radius at 0 and 5 minutes are shown in the table below.

| | Radius (micron) | Standard | Radius (micron) | Standard |
|---|---|---|---|---|
| | 0 minutes | deviation | 5 minutes | deviation |
| Reference | 47.0 | 4.36 | 168.0 | 65.87 |
| Invention | 44.5 | 2.12 | 89.5 | 9.19 |

The foam volume for both samples was also monitored for 5 minutes and it was found that the foam volume of the inventive sample decreased slower than the foam volume of the reference sample.

1. A foaming creamer composition comprising
an emulsion comprising casein or a salt thereof and an oil, wherein the weight ratio of casein or salt thereof to oil is about 0.005:1 to about 0.035:1; and
a foamer ingredient comprising gas under pressure.

2. A foaming creamer composition according to claim 1, wherein the emulsion comprises about 0.20 wt. % to about 1.20 wt. % casein or salt thereof.

3. A foaming creamer composition according to claim 1, wherein the composition is in the form of a powder.

4. A foaming creamer composition according to claim 1, wherein the casein or salt thereof is selected from the group consisting of: micellar casein, sodium caseinate, potassium caseinate and calcium caseinate.

5. A foaming creamer composition according to claim 1, wherein the oil is selected from the group consisting of: palm oil, palm kernel oil or olein, hydrogenated palm kernel oil or olein, coconut oil, algal oil, canola oil, soy bean oil, sunflower oil, safflower oil, cotton seed oil, milk fat, and corn oil.

6. A foaming creamer composition according to claim 1, wherein the composition comprises a sweetener.

7. A foaming creamer composition according to claim 1, wherein the composition does not comprise a low molecular weight emulsifier.

8. A foaming creamer composition according to claim 1, wherein the composition comprises about 10 wt. % to about 80 wt. % oil.

9. A foaming creamer composition according to claim 1, wherein the foamer ingredient comprising gas under pressure releases at least 1 ml of gas at ambient conditions per gram of soluble foamer ingredient by contact with a liquid.

10. A foaming creamer composition according to claim 1, wherein the oil comprises one or more added aroma components.

11. (canceled)

12. A coffee beverage composition comprising an emulsion comprising casein or a salt thereof and an oil, wherein the weight ratio of casein or salt thereof to oil is about 0.005:1 to about 0.035:1, and a foamer ingredient comprising gas under pressure.

13. A process for providing a dried foaming creamer composition comprising the steps of:
providing an aqueous phase comprising casein or a salt thereof;
providing an oil phase comprising an oil, and optionally a low molecular weight emulsifier;
combining the aqueous phase and the oil phase to form a pre-emulsion;
homogenising the pre-emulsion to form an emulsion concentrate;
drying the emulsion concentrate to form a dried creamer composition; and
mixing the dried emulsion with a powdered foamer ingredient comprising gas under pressure.
